(19) United States
(12) Patent Application Publication
(10) Pub. No.: US 2017/0048899 A1
(43) Pub. Date: Feb. 16, 2017

(54) CONNECTION IDENTIFIER FOR HIGH-EFFICIENCY WIRELESS NETWORKS

(71) Applicants: HONGGANG LI, Beijing (CN); QINGHUA LI, San Ramon, CA (US); HUANING NIU, Milpitas, CA (US); HUJUN YIN, Saratoga, CA (US); THOMAS KENNEY, Portland, OR (US); Intel IP Corporation, Santa Clara, CA (US)

(72) Inventors: HONGGANG LI, BEIJING (CN); QINGHUA LI, SAN RAMON, CA (US); HUANING NIU, MILPITAS, CA (US); HUJUN YIN, SARATOGA, CA (US); THOMAS KENNEY, PORTLAND, OR (US)

(73) Assignee: Intel IP Corporation, Santa Clara, CA (US)

(21) Appl. No.: 15/306,427

(22) PCT Filed: Apr. 24, 2014
(86) PCT No.: PCT/CN2014/076100

§ 371 Date: Oct. 24, 2016

(51) Int. Cl. H04W 76/02

(52) U.S. Cl. CPC H04W 76/021; H04W 80/02

(57) ABSTRACT

Various embodiments are generally directed to techniques to identify the target of a packet in a wireless network. A transmitter node may include a connection identifier to generate a unique identifier corresponding to a connection between the transmitter node and a receiver node in the wireless network and a data packet transmitter to embed the unique identifier into a physical layer convergence protocol header corresponding to a packet to be transmitted to the receiver node. A node may include a data packet receiver to receive a physical layer convergence protocol header corresponding to a packet to be transmitted from a transmitter node in the wireless network to a receiver node in the wireless network and a header decoder to decode a unique identifier from the physical layer convergence protocol header, the unique identifier corresponding to a connection between the transmitter node and the receiver node.

### TECHNICAL FIELD

Embodiments described herein generally relate to wireless networks and particularly to identifying connections in high-efficiency wireless networks.

### BACKGROUND

Electronic devices, such as laptops, notebooks, netbooks, personal digital assistants (PDAs) and mobile phones, for example, increasingly tend to include a variety of wireless communication capabilities. These devices often include the ability to connect to a wireless local area network (e.g., using Wi-Fi, or the like). With the proliferation of such wireless capable devices, the number of users on various wireless networks is increasing. As a result of this increase in users, the need for error correction, interference mitigation, and power saving features has increased.

Some current wireless technologies(e.g., WiFi,) however, may not be able to provide these desired features. For example, some wireless connection technologies embed the address of the transmitter and receiver for a particular data packet in the payload portion of the packet. As such, to identify the intended recipient of the packet, each receiver in the system has to decode the entire data packet. As will be appreciated, packets may be addressed to a single receiver in the system. Accordingly, in such cases, receivers in the system extend unnecessary power decoding the packets not addressed to them, resulting in an inefficient usage of power. This is particularly important for mobile devices that may operate from a battery power source.

Furthermore, if the payload portion of the packet is not correctly received, the receiver will not know the transmitters address, and thus, cannot request an incremental retransmission of the data. Additionally, a receiver cannot null out an interfering signal, as the receiver must wait until the entire packet is received and decoded before determining if the packet corresponding to that signal is intended for that receiver.

The present disclosure is directed to the above noted shortcomings and inefficiencies.

### BRIEF DESCRIPTION OF THE DRAWINGS

FIG. 1 illustrates an example wireless network according to an embodiment.

FIG. 2 illustrates an example wireless data transmission technique according to an embodiment.

FIG. 3 illustrates an example transmitter node according to an embodiment.

FIG. 4 illustrates an example receiver node according to an embodiment.

FIG. 5 illustrates an example method according to an embodiment.

FIG. 6 illustrates another example method according to an embodiment.

FIG. 7 illustrates another example wireless data transmission technique according to an embodiment.

FIG. 8 illustrates an example storage medium according to an embodiment.

FIG. 9 illustrates a device according to an embodiment.

### DETAILED DESCRIPTION

Examples are generally directed to embedding a unique identifier corresponding to a wireless connection between a transmitter and a receiver in a physical layer header of a packet.

Accordingly, a particular receiver may decode the header and determine if the packet is intended for the particular receiver before decoding the payload portion of the packet.

Various embodiments of the present disclosure may be included with or implemented by nodes (e.g., access points, stations, mobile devices, or the like) that may be configured to operate in accordance with various wireless network standards. In some examples, these wireless network standards may include standards promulgated by the Institute of Electrical Engineers (IEEE), or other standard setting organizations. With a particularly illustrative example, some embodiments may be implemented in accordance with the IEEE 802.11 High-Efficiency Wireless (HEW) standard.

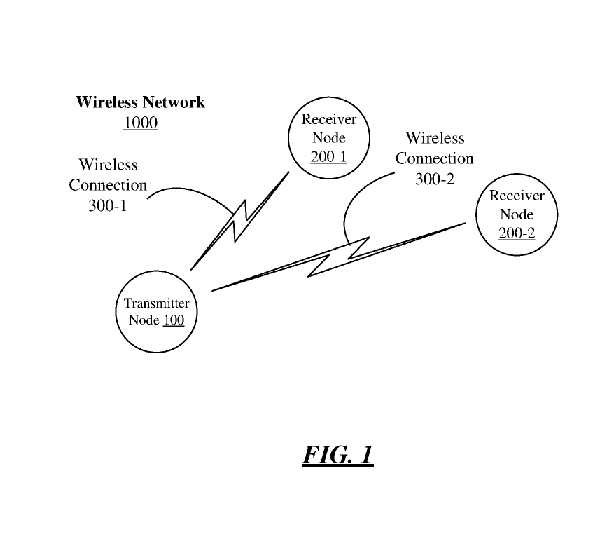

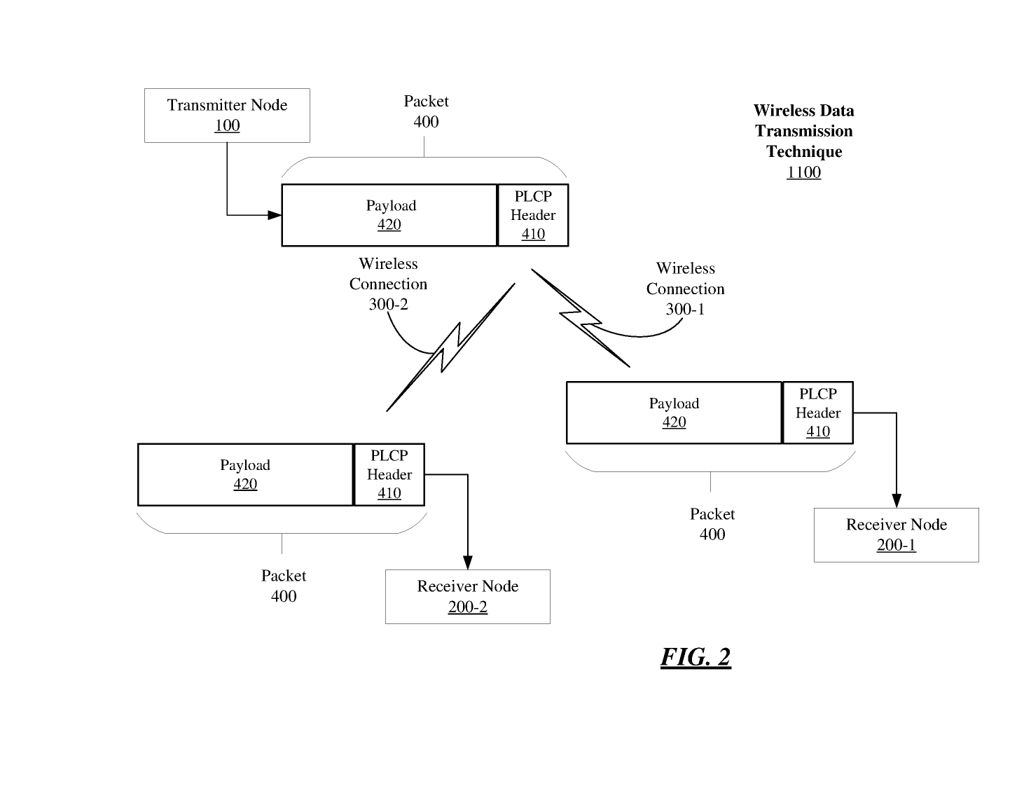

FIGS. 1-2 are block diagrams illustrating an example wireless network 1000 and wireless data transmission technique 1100. In general, FIG. 1 illustrates the wireless network 1000 while FIG. 2 illustrates the wireless data transmission technique 1100 using the wireless network 1000. As depicted, the network 1000 shows a number of nodes wirelessly connected. During operation, data may be transmitted between the nodes of the network 1000 using the wireless connections. It is noted, that the number of nodes is illustrated at a quantity to facilitate understanding and is not intended to be limiting. Furthermore, in some embodiments, a single node may behave as both a transmitter and a receiver. The present disclosure, however, describes nodes as either a transmitter node or a receiver node for purposes of clarity only and is not intended to be limiting. Additionally, with some examples, the depicted receiver nodes are referenced in singular format. Said differently, some examples refer to a single one of the receiver nodes. It is to be appreciated that any one of the receiver nodes depicted in the wireless network 1000 may be referenced, and referring to the receiver nodes in singular form is merely done for clarity in describing the various examples.

Turning more specifically to FIG. 1, the wireless network 1000 is depicted including a transmitter node 100 and receiver nodes 200-1 and 200-2. The transmitter node 100 is depicted wirelessly connected to the receiver node 200-1 using the wireless connection 300-1. Additionally, the transmitter node 100 is depicted wirelessly connected to the receiver node 200-2 using the wireless connection 300-2.

In some examples, the wireless network 1000 may correspond to a wireless local area network. As such, one of the nodes (e.g., the transmitter node 100) may be a wireless access point (e.g., a wireless router, a wireless switch, or the like) while the other nodes (e.g., the receiver nodes 200) may be devices (e.g., a laptop, a tablet, a smartphone, a printer, a storage device, or the like) accessing the wireless network 1000. As such, the nodes (e.g., the transmitter node 100 and the receiver nodes 200) may operate in compliance with at least one or more wireless communication standards. As a particularly illustrative example, the nodes (e.g., the transmitter node 100 and the receiver nodes 200) may operate in compliance with the IEEE 802.11HEW standard.

Turning more specifically to FIG. 2, an exemplary wireless data transmission technique 1100 is shown where a packet 400 is being transmitted from the transmitter node 100. More specifically, the transmitter node 100 transmits the packet 400 over the wireless connections 300-1 and 300-2 while the receiver nodes 200-1 and 200-2 receive the packet 400 over the wireless connections 300-1 and 300-2, respectively.

As will be appreciated, however, during operation, some of the packets transmitted by the transmitter node 100 may only be intended for one of the receiver nodes 200. For example, the packet 400 may be intended for the receiver node 200-1. However, due to the nature of wireless connections, the receiver node 200-2 may also receive the packet 400. Said differently, the transmitter node 100 may transmit signals corresponding to the packet 400 over a wireless frequency corresponding to the wireless connections 300-1 and 300-2. As such, the receiver nodes 200-1 and 200-2 may both receive the signals corresponding to the packet 400.

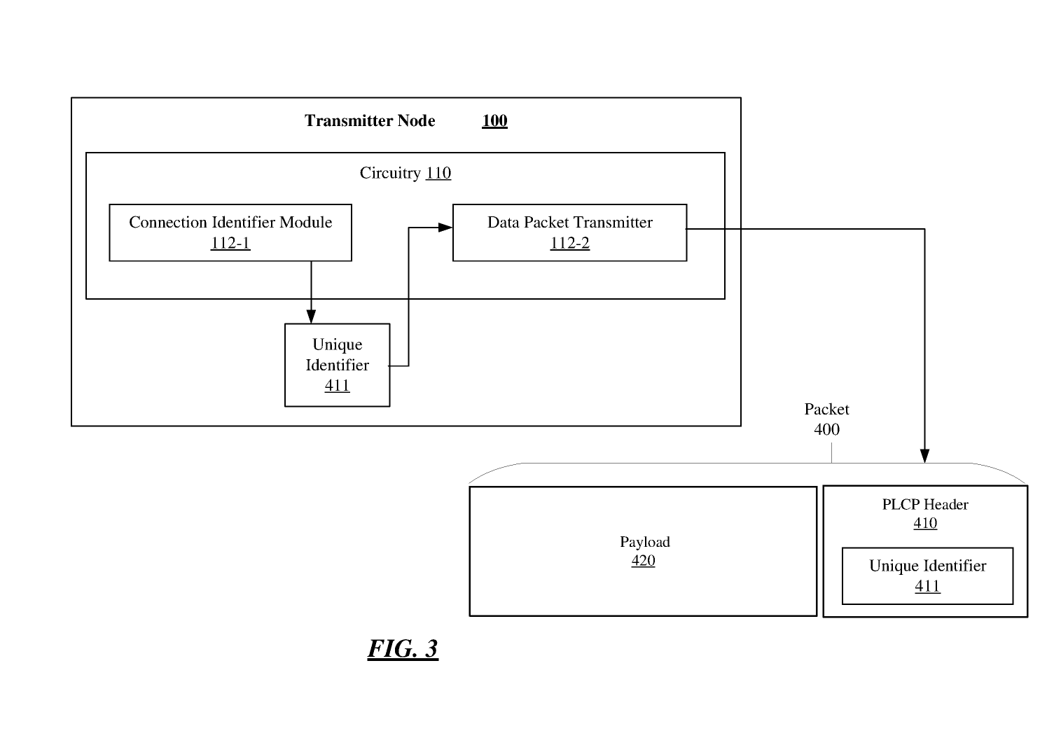

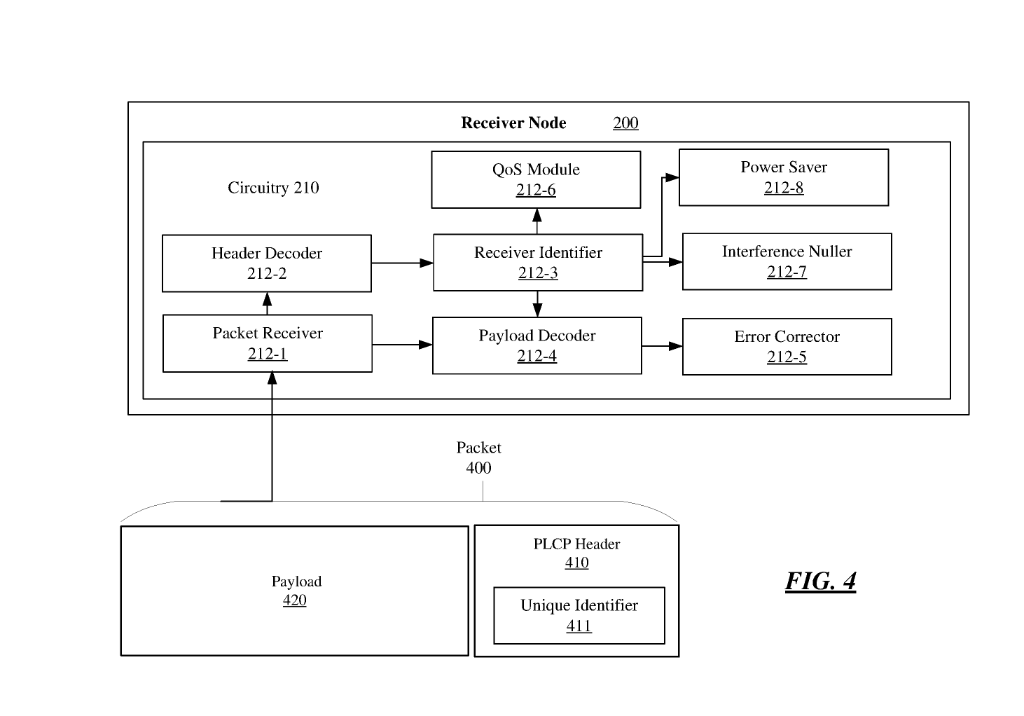

The present disclosure provides that a particular receiver node (e.g., the receiver node 200-1 and/or 200-2) may determine if the packet 400 is intended for that particular receiver node prior to receiving and/or decoding the entire packet. In general, the present disclosure provides that a unique identifier (e.g., refer to FIGS. 3-4) may be embedded in a header (described in greater detail below) for of the packet. The unique identifier corresponds to a connection between the transmitter node 100 and the receiver node to which the packet 400 is intended. More specifically, as depicted, the packet 400 includes a physical layer convergence protocol (PLCP) header 410 and a data payload 420. In general, the PLCP header 410 includes information needed by the receiver nodes 200-1 and 200-2 to receive and decode the data payload 420. Various embodiments of the present disclosure, however, provide that a unique identifier may be embedded in the PLCP header 410. Accordingly, the receiver nodes 200-1 and 200-2 may decode the PLCP header 410 and determine whether the packet 400 is intended for them or not. The receiver nodes 200-1 and 200-2 may then take various actions depending upon whether the packet 400 is intended for them or not.

For example, assuming that the packet 400 is intended for the receiver node 200-1, the receiver node 200-1 may decode the data payload 420 based on the determination that the receiver node 200-1 is the intended target for the packet 400. As another example, in the event that the packet 400 is incorrectly received, the receiver node 200-1 may implement an error correction process (e.g., a hybrid automatic repeat request, often referred to as HARQ, or the like)based on the determination that the packet 400 is intended for the receiver node 200-1. As another example, the receiver node 200-1 may adjust various quality of service (QoS) parameters to increase the quality of transmission of the data payload 420 over the wireless connection 300.

Under the same assumption that the packet 400 is intended for the receiver node 200-1, the receiver node 200-2 may take various actions based on the determination that the packet is not intended for the receiver node 200-2. For example, the receiver node 200-2 may implement various signal nulling techniques based on the determination that the receiver node 200-2 is not the intended target for the packet 400. As another example, the receiver node 200-2 may enter a power saving mode based on the determination that the receiver node 200-2 is not the intended target for the packet 400. As such, the receiver node 200-2 may not decode the data payload portion of the packet 400.

FIGS. 3-4 illustrate examples of a transmitter node 100 and a receiver node 200, arranged according to at least one embodiment of the present disclosure. In general, FIG. 3 depicts the example transmitter node 100 while FIG. 4 depicts the example receiver node 200. The transmitter node 100 and the receiver node 200 each include circuitry. For example, the transmitter node 100 includes circuitry 110 while the receiver node 200 includes circuitry 210. In general, the circuitry 110 and 210 may each be arranged to execute one or more components 112-a and 212-a, respectively. The circuitry 110 and/or 210 may be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Qualcomm® Snapdragon®, Intel® Celeron®, Core (2) Duo®, Core i3, Core i5, Core i7, Itanium®, Pentium®, Xeon®, Atom® and XScale® processors; and similar processors. Dual microprocessors, multi-core processors, and other multi-processor architectures may also be employed as the circuitry 110 and/or 210. According to some examples, the circuitry 110 and/or 210 may also be an application specific integrated circuit (ASIC) and components 112-a and/or 212-a may be implemented as hardware elements of the ASIC. According to some examples the circuitry 110 and/or 210 may also be a field programmable gate array (FPGA) and components 112-a and/or 212-a may be implemented as hardware elements of the FPGA.

Turning more specifically to FIG. 3, according to some examples, the transmitter node 100 may include a connection identifier 112-1. The circuitry 110 may execute the connection identifier 112-1 to generate a unique identifier corresponding to a connection between the transmitter node and a receiver node in the wireless network. For example, the circuitry 110 may execute the connection identifier 112-1 to generate a unique identifier 411 corresponding to a connection between the transmitter node 100 and a receiver node 200. As a particularly illustrative example, the circuitry 110 may execute the connection identifier 112-1 to generate the unique identifier 411 to correspond with the wireless connection 300-1. As such, the unique identifier 411 would correspond to the connection between the transmitter node 100 and the receiver node 200-1.

With some examples, the unique identifier 411 may be pre-assigned (e.g., generated by an access point in the wireless network 1000, or the like). As such, the connection identifier 112-1 may identify the pre-assigned unique identifier for the wireless connection as the unique identifier 411. In some examples, the connection identifier 112-1 may generate the unique identifier 411 randomly (e.g., using a random generation scheme, or the like). In some examples, the connection identifier 112-1 may generate the unique identifier 411 by allocating the unique identifier from a pool of available unique identifiers.

In some examples, a single unique identifier 411 may be generated to correspond to a connection between a transmitter node and a receiver node. For example, in FIGS. 3-4, a single unique identifier 411 is depicted. With some examples, a first unique identifier 411 may be generated to correspond to a receiver and a second unique identifier to correspond to a transmitter. For example, some wireless transmission techniques (e.g., 802.11ac, or the like) provide an identifier corresponding to a receiver node. With some examples, this identifier may be used as a first unique identifier 411 to correspond to the receiver node 200 to which the packet 400 is intended and a second unique identifier 411 may be generated to correspond to the transmitter node 100 so that the receiver nodes may be able to determine both the intended recipient and the transmitter of the packet 400.

With some examples, the unique identifier 411 may have a length (e.g., in bits, or the like) that provides for the collision rate of two randomly generated unique identifiers to be sufficiently low. For example, for a denser network (e.g., greater number of nodes) the unique identifier may have a longer length to provide less chance that two identical unique identifies will be randomly generated. With some examples, the unique identifier 411 may have a length of between 4 and 8 bits. With some examples, the unique identifier 411 may have a length of between 4 and 20 bits. With some examples, the length of the unique identifier may depend upon the density of the wireless network.

It is important to note, that in some examples, although the identifier 411 is referred to as “unique” there may be examples where multiple nodes generate the same value for their unique identifier 411. For example, two nodes may generate the same identifier 411 if they do not coordinate with each other. Some implementations may allow this provided that the collision rate is small.

As another examples, a node other than the transmitter node 100 may assign the unique identifier 411. For example, in some cases, an access point may allocate unique identifiers for all the links to its subscribers and the links from its subscribers. In the case of links from its subscribers, the subscriber transmitter does not generate the identifier but may use the identifier assigned by the access point.

In some examples, the transmitter node 100 may include a data packet transmitter 112-2. The circuitry 110 may execute the data packet transmitter 112-2 to embed the unique identifier into a PLCP header corresponding to a packet to be transmitted to the receiver node. For example, the circuitry 110 may execute the data packet transmitter 112-2 to embed the unique identifier 411 into the PLCP header 410 of the packet 400. With some examples, the data packet transmitter 112-2 may embed the unique identifier 411 into a HEW signal field in the PLCP header 410.

It is to be appreciated, that the transmitter node 100 may generate a number of different unique identifiers. For example, a unique identifier may be generated for each wireless connection 300. Furthermore, with some examples, a packet 400 may be intended for multiple receiver nodes. As such, the data packet transmitter 112-2 may embed multiple unique identifiers in the PLCP header 410. Additionally, multicast or broadcast identifiers may be embedded in the PLCP header 410. As such, the receiver nodes 200 may determine which receivers the packet 400 is intended for prior to decoding the data payload 420.

Turning more specifically to FIG. 4, the receiver node 200 may include a data packet receiver 212-1, a header decoder 212-2, and a receiver identifier 212-3. The circuitry 210 may execute the data packet receiver 212-1 to receive a PLCP header corresponding to a packet to be transmitted from a transmitter node in the wireless network to a receiver node in the wireless network. For example, the circuitry 210 may execute the data packet receiver 212-1 to receive the PLCP header 410 from the packet 400. The circuitry 210 may execute the header decoder 212-2 to decode a unique identifier from the PLCP header. For example, the circuitry 210 may execute the header decoder 212-2 to decode the unique identifier 411 from the PLCP header 410. As detailed above, the unique identifier 411 corresponds to a wireless connection 300 between the transmitter node 100 and a receiver node 200 in the wireless network 1000. In particular, the unique identifier 411 corresponds to a wireless connection with a receiver node 200 for which the packet 400 is intended.

The circuitry 210 may execute the receiver identifier 212-3 to determine whether the receiver node 200 is the receiver node in the wireless system with which the packet 400 is intended. Said differently, the receiver identifier 212-3 may determine based on the unique identifier 411 whether the receiver 200 is the target for the packet 400. The receiver 200 may further include a payload decoder 212-4, an error corrector 212-5, and a QoS module 212-6. The circuitry 210 may execute the payload decoder 212-4 to receive the data payload 420 of the packet 400 and decode the data payload 420 based on the determination that the receiver node 200 is the target of the packet 400. The circuitry 210 may execute the error corrector 212-5 to determine whether a portion of the data payload 420 was not correctly received and request a retransmission of the data payload 420 from transmitter node 100. For example, the error corrector 212-5 may initiate a HARQ error correction process.

The circuitry 210 may execute the QoS module 212-6 to apply a transmission scheme to a signal corresponding to the packet based on the determination that the node in the wireless system does correspond to the receiver node in the wireless system. With some examples, the QoS module 212-6 may apply a transmission scheme (e.g., transmission modulation scheme, or the like) based on a QoS requirement for the packet 400. As will be appreciated, in practice, the receiver node 200 may have multiple simultaneous connections, where each connection may have a different QoS requirement. As such, the circuitry 210 may execute the QoS module 212-6 to apply a suitable transmission scheme for the QoS requirements of the wireless connection corresponding of the unique identifier 411. It is important to note, that the circuitry 210 may execute the QoS module 212-6 to apply a transmission schemes on a per packet basis to satisfy various QoS requirements.

The receiver 200 may further include an interference nuller 212-7 and a power saver 212-8. The circuitry 210 may execute the interference nuller 212-7 to apply interference nulling to a signal corresponding to the packet based on the determination that the node in the wireless system does not correspond to the receiver node in the wireless system. The circuitry 210 may execute the power saver 212-8 to initiate a power saving operation in the receiver node 200 based on the determination that the node in the wireless system does not correspond to the receiver node in the wireless system. For example the power saver 212-8 may cause components of the receiver node 200 to enter a reduced power or sleep state based on the determination that the receiver node 200 is not the target of the packet 400.

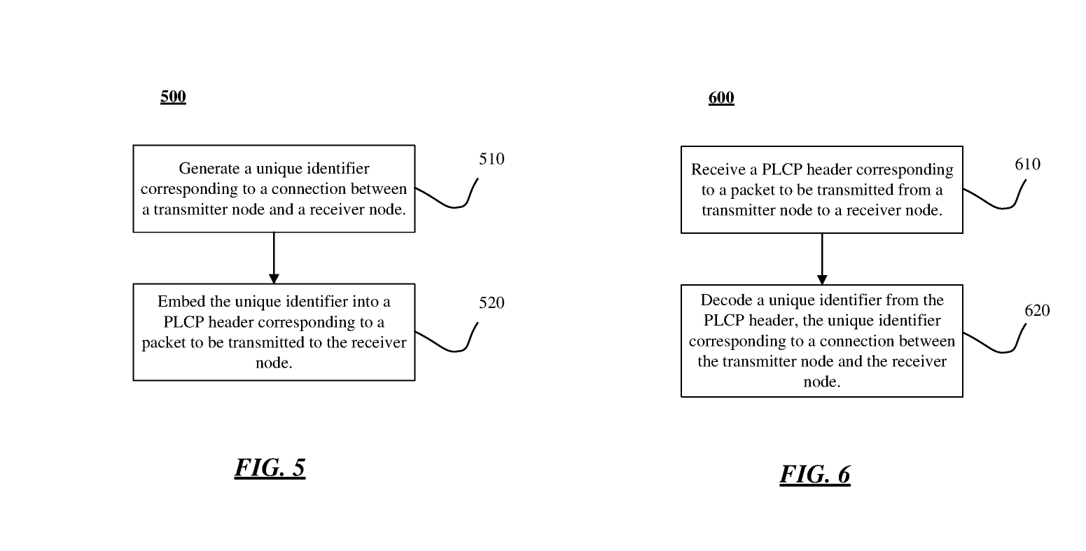

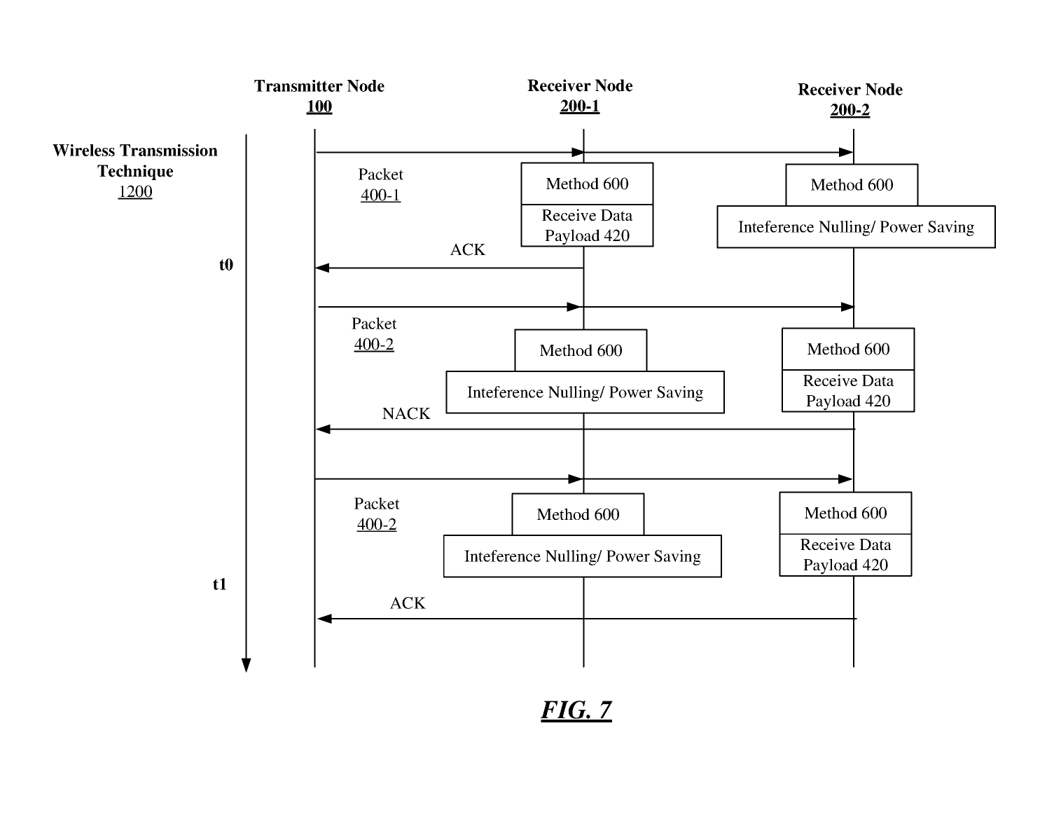

FIGS. 5-6 illustrate examples of logic flows 500 and 600, respectively. In general, the logic flows 500 and/or 600 may be representative of some or all of the operations executed by one or more logic, features, or devices described herein, such as the transmitter node 100 and/or the receiver nodes 200 of the wireless network 1000. In particular, the method 500 may be representative of some or all of the operations implemented by the transmitter node 100 while the method 600 may be representative of some of all of the operations implemented by the receiver nodes 200.

Turning more specifically to FIG. 5, in the logic flow 500, at block 510, generate a unique identifier corresponding to a connection between a transmitter node and a receiver node; a unique identifier is generated. For example, the connection identifier 112-1 may generate the unique identifier 411.

At block 520, embed the unique identifier into a PLCP header corresponding to a packet to be transmitted to the receiver node; the unique identifier is embedded into a PLCP header of a packet targeted at the receiver associated with the unique identifier. For example, the data packet transmitter 112-2 may embed the unique identifier 411 into the PLCP header 410 of the packet 400.

Turning more specifically to FIG. 6, in the logic flow 600, at block 610, receive a PLCP header corresponding to a packet to be transmitted from a transmitter node to a receiver node; a PLCP header is received. For example, the data packet receiver 212-1 may receive the PLCP header 410 corresponding to the packet 400.

At block 620, decode a unique identifier from the PLCP header, the unique identifier corresponding to a connection between the transmitter node and the receiver node; a unique identifier may be decoded from the PLCP header. For example, the header decoder 212-2 may decode the unique identifier 411 from the PLCP header 410.

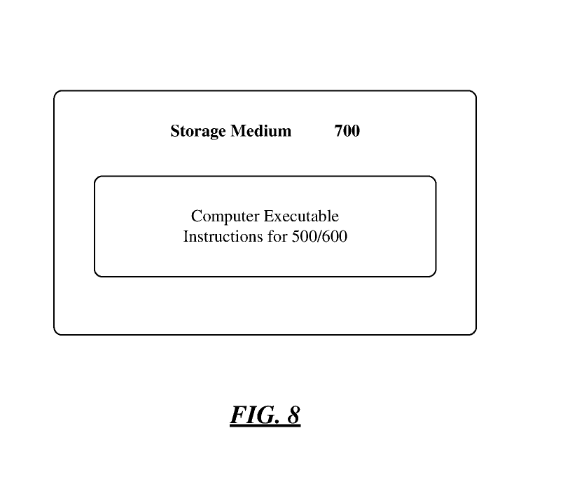

FIG. 7 illustrates an example wireless transmission flow 1200, arranged according to various embodiments of the present disclosure. In general, the example 1200 depicts hypothetical transmission of packets from the transmitter node 100 to the receiver nodes 200. It is to be appreciated that this example is not intended to be limiting but is merely provided for purposes of clarity and completeness.

The transmitter node 100 may transmit a packet 400-1. The receiver nodes 200-1 and 200-2 may receive the packet 400-1 and implement the method 600 to determine the target for the packet by decoding the unique identifier from the PLCP header of the packet 410-1. For example, assuming that the packet 400-1 is intended for the receiver node 200-1, the receiver node 200-1 may determine that it is the target of the packet 400-1 by implementing the method 600. As such, the receiver node 200-1 may receive the data payload portion (e.g., the data payload 420) of the packet 400-1. Additionally, the receiver 200-2 may determine that it is not the target of the packet 400-1 by implementing the method 600. As such, the receiver node 200-2 may implement various interference nulling and/or power saving procedures. Furthermore, the receiver 200-1 may respond to the reception of the packet, and particularly the reception of the data payload 420, with an acknowledgment (ACK) signal transmitted back to the transmitter node 100.

The transmitter node 100 may transmit a packet 400-2. The receiver nodes 200-1 and 200-2 may receive the packet 400-2 and implement the method 600 to determine the target for the packet by decoding the unique identifier from the PLCP header of the packet 410-2. For example, assuming that the packet 400-2 is intended for the receiver node 200-2, the receiver node 200-2 may determine that it is the target of the packet 400-2 by implementing the method 600. As such, the receiver node 200-2 may receive the data payload portion (e.g., the data payload 420) of the packet 400-2. Additionally, the receiver node 200-1 may determine that it is not the target of the packet 400-2 by implementing the method 600. As such, the receiver node 200-1 may implement various interference nulling and/or power saving procedures. The receiver node 200-2 may initiate error correction procedures (e.g., negative acknowledgement (NACK), HARQ, or the like) if the data payload of the packet 400-2 is not correctly received. As such, the transmitter node 100 may resend the packet 400-2.

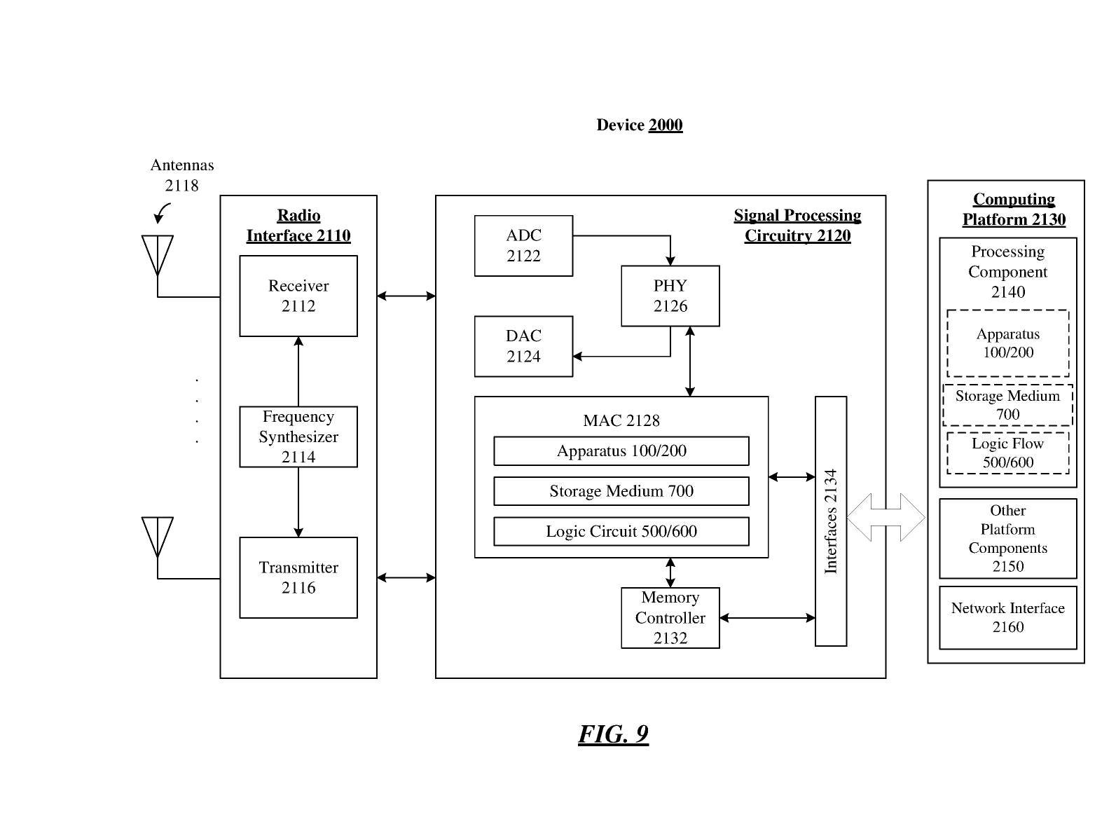

FIG. 8 illustrates an embodiment of a storage medium 700. The storage medium 700 may comprise an article of manufacture. In some examples, the storage medium 700 may include any non-transitory computer readable medium or machine readable medium, such as an optical, magnetic or semiconductor storage. The storage medium 700 may store various types of computer executable instructions, such as instructions to implement logic flow 500 and/or 600. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

FIG. 9 illustrates an embodiment of a device 2000. In some examples, device 2000 may be configured or arranged to provide for the identification of wireless connections in a wireless network (e.g., the wireless network 1000) as described herein. In some examples, the device 2000 may be implemented in the transmitter node 100, the receiver node 200-1, and/or the receiver node 200-2. In some examples, the device 2000 may include at least one antenna 2118 to communicate over the wireless connections 300 while the circuitry 110 and/or 210 may be implemented as signal processing circuitry 2120 and/or computing platform 2130. Additionally, the device 2000 may implement storage medium 700, logic circuit 500, and/or logic circuit 600. The logic circuits 500 and/or 600 may include physical circuits to perform operations described for the apparatus 100 and/or 200, storage medium 700, and/or logic flows 500 and/or 600. Examples are, however, not limited in this context.

The device 2000 may implement some or all of the structure and/or operations for the apparatus 100, the apparatus 200, the storage medium 700, the logic circuit 500, and/or the logic circuit 600 in a single computing entity, such as entirely within a single device. The embodiments are not limited in this context.

Radio interface 2110 may include a component or combination of components adapted for transmitting and/or receiving single carrier or multi-carrier modulated signals (e.g., including complementary code keying (CCK) and/or orthogonal frequency division multiplexing (OFDM) symbols and/or single carrier frequency division multiplexing (SC-FDM symbols) although the embodiments are not limited to any specific over-the-air interface or modulation scheme. Radio interface 2110 may include, for example, a receiver 2112, a transmitter 2116 and/or a frequency synthesizer 2114. Radio interface 2110 may include bias controls, a crystal oscillator and antennas 2118. In another embodiment, radio interface 2110 may use external voltage-controlled oscillators (VCOs), surface acoustic wave filters, intermediate frequency (IF) filters and/or RF filters, as desired. Due to the variety of potential RF interface designs an expansive description thereof is omitted.

Signal processing circuitry 2120 may communicate with radio interface 2110 to process receive and/or transmit signals and may include, an analog-to-digital converter 2122 and/or a digital-to-analog converter 2124 for use in processing receive/transmit signals(e.g., up converting, down converting, filtering, sampling or the like.) Further, signal processing circuitry 2120 may include a baseband or physical layer (PHY) processing circuit 2126 for PHY link layer processing of respective receive/transmit signals. Signal processing circuitry 2120 may include, for example, a processing circuit 2128 for medium access control (MAC)/data link layer processing. Signal processing circuitry 2120 may include a memory controller 2142 for communicating with MAC processing circuit 2128 and/or a computing platform 2130, for example, via one or more interfaces 2144.

The MAC 2128 may be configured to include the apparatus 100 and/or 200. As another example, the MAC 2128 may be configured to include the storage medium 700. As another example, the MAC 2128 may be configured to implement logic circuit 500 and/or 600. As another example, the MAC 2128 may access the computing platform 2130 to implement and/or perform the structure and/or methods described herein.

In some examples, the PHY 2126 may be configured to include and/or perform the structures and/or methods described herein. With some embodiments, PHY processing circuitry 2126 may include a frame construction and/or detection module, in combination with additional circuitry such as a buffer memory, to construct and/or deconstruct communication frames (e.g., containing subframes). Alternatively or in addition, MAC processing circuit 2128 may share processing for certain of these functions or perform these processes independent of PHY processing circuit 2126. In some embodiments, MAC and PHY processing may be integrated into a single circuit.

Computing platform 2130 may provide computing functionality for device 2000. As shown, computing platform 2130 may include a processing component 2140. In addition to, or alternatively of, signal processing circuitry 2120 of device 2000 may execute processing operations or logic for the apparatus 100 and/or 200, storage medium 700, and logic circuit 500 and/or 600 using the processing component 2140. Processing component 2140 (and/or PHY 2126 and/or MAC 2128) may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

Computing platform 2130 may further include other platform component 2150. Other platform components 2150 include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

Computing platform 2130 may further include a network interface 2160. In some examples, network interface 2160 may include logic and/or features to support network interfaces operated in compliance with one or more wireless broadband technologies such as those described in one or more standards associated with IEEE 802.11 such as IEEE 802.11u or with technical specification such as WFA Hotspot 2.0.

Device 2000 may be part of a transmitter and/or receiver node in a wireless network and may be included in various types of computing devices to include, but not limited to, user equipment, a computer, a personal computer (PC), a desktop computer, a laptop computer, a notebook computer, a netbook computer, a tablet computer, an ultra-book computer, a smart phone, embedded electronics, a gaming console, a server, a server array or server farm, a web server, a network server, an Internet server, a work station, a mini-computer, a main frame computer, a supercomputer, a network appliance, a web appliance, a distributed computing system, multiprocessor systems, processor-based systems, wearable computing device or combination thereof. Accordingly, functions and/or specific configurations of device 2000 described herein; may be included or omitted in various embodiments of device 2000, as suitably desired. In some embodiments, device 2000 may be configured to be compatible with protocols and frequencies associated with IEEE 802.11 Standards, although the examples are not limited in this respect.

The components and features of device 2000 may be implemented using any combination of discrete circuitry, application specific integrated circuits (ASICs), logic gates and/or single chip architectures. Further, the features of device 2000 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary device 2000 shown in the block diagram of FIG. 9 may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled”, “connected”, or “capable of being coupled” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. The detailed disclosure now turns to providing examples that pertain to further embodiments. The examples provided below are not intended to be limiting.

### EXAMPLE 1

An apparatus for a transmitter node in a wireless network. The apparatus may comprise a connection identifier to generate a unique identifier corresponding to a connection between the transmitter node and a receiver node in the wireless network and a data packet transmitter to embed the unique identifier into a physical layer convergence protocol header corresponding to a packet to be transmitted to the receiver node.

### EXAMPLE 2

The apparatus of example 1, wherein the data packet transmitter embeds the unique identifier into a high-efficiency wireless local area network (HEW) signal field in the physical layer convergence protocol header.

### EXAMPLE 3

The apparatus of either of examples 1 to 2, wherein the connection identifier randomly generates the unique identifier.

### EXAMPLE 4

The apparatus of either of examples 1 to 2, wherein the connection identifier allocates the unique identification from a pool of available unique identifiers.

### EXAMPLE 5

The apparatus of either of examples 1 to 2, wherein the unique identifier is a first unique identifier and the receiver node is a first receiver node, the connection identification to generate a second unique identifier corresponding to a connection between the transmitter node and a second receiver node in the wireless network.

### EXAMPLE 6

The apparatus of example 5, wherein the packet is to be transmitted to the second receiver node, the data packet transmitter to embed the second unique identifier into the physical layer convergence protocol header corresponding the packet.

### EXAMPLE 7

The apparatus example 2, wherein the transmitter node and the receiver node are configured to operate on the 802.11HEW wireless standard.

### EXAMPLE 8

The apparatus of either of examples 1 to 2, wherein the unique identifier is between 4 and 20 bits.

### EXAMPLE 9

The apparatus of either of examples 1 to 2, wherein the unique identifier is between 4 and 8 bits.

### EXAMPLE 10

The apparatus of either of examples 1 to 2, wherein the transmitter node is an access point in the wireless network.

### EXAMPLE 11

An apparatus for a node in a wireless network. The apparatus may comprise a data packet receiver to receive a physical layer convergence protocol header corresponding to a packet to be transmitted from a transmitter node in the wireless network to a receiver node in the wireless network and a header decoder to decode a unique identifier from the physical layer convergence protocol header, the unique identifier corresponding to a connection between the transmitter node and the receiver node.

### EXAMPLE 12

The apparatus of example 11, further comprising a receiver identifier to determine whether the node in the wireless system corresponds to the receiver node in the wireless system based at least in part on the unique identifier.

### EXAMPLE 13

The apparatus of example 12, further comprising an interference nuller to apply interference nulling to a signal corresponding to the packet based on the determination that the node in the wireless system does not correspond to the receiver node in the wireless system.

### EXAMPLE 14

The apparatus of example 12, further comprising a quality of service module to apply a transmission scheme to a signal corresponding to the packet based on the determination that the node in the wireless system does correspond to the receiver node in the wireless system.

### EXAMPLE 15

The apparatus of example 14, the quality of service module to determine the transmission scheme based at least in part on a quality of service requirement for the packet.

### EXAMPLE 16

The apparatus of example 12, further comprising a power saver to initiate a power saving operation in the node based on the determination that the node in the wireless system does not correspond to the receiver node in the wireless system.

### EXAMPLE 17

The apparatus of example 12, further comprising a payload decoder to receive the packet and decode the packet based on the determination that the node in the wireless system does correspond to the receiver node in the wireless system.

### EXAMPLE 18

The apparatus of example 17, further comprising an error corrector to determine whether a portion of the packet was not correctly received and request a retransmission of the packet from transmitting node based on the determination that the portion of the packet was not correctly received.

### EXAMPLE 19

The apparatus of either of examples 11 to 18, wherein the unique identifier is in a high-efficiency wireless local area network (HEW) signal field in the physical layer convergence protocol header.

### EXAMPLE 20

The apparatus of example 19, wherein the transmitter node and the receiver node are configured to operate on the 802.11HEW wireless standard.

### EXAMPLE 21

The apparatus of either of examples 11 to 18 or 20, wherein the transmitter node is an access point in the wireless network and the node is a station in the wireless network.

### EXAMPLE 22

A method implemented by a transmitter node in a wireless network. The method may comprise generating a unique identifier corresponding to a connection between the transmitter node and a receiver node in the wireless network and embedding the unique identifier into a physical layer convergence protocol header corresponding to a packet to be transmitted to the receiver node.

### EXAMPLE 23

The method of example 22, further comprising embedding the unique identifier into a high-efficiency wireless local area network (HEW) signal field in the physical layer convergence protocol header.

### EXAMPLE 24

The method of either of examples 22 to 23, further comprising randomly generating the unique identifier.

### EXAMPLE 25

The method of either of examples 22 to 23, further comprising allocating the unique identification from a pool of available unique identifiers.

### EXAMPLE 26

The method of either of examples 22 to 23, wherein the unique identifier is a first unique identifier and the receiver node is a first receiver node, the method further comprising generating a second unique identifier corresponding to a connection between the transmitter node and a second receiver node in the wireless network.

### EXAMPLE 27

The method of example 26, wherein the packet is to be transmitted to the second receiver node, the method further comprising embedding the second unique identifier into the physical layer convergence protocol header corresponding the packet.

### EXAMPLE 28

The method of example 23, wherein the transmitter node and the receiver node are configured to operate on the 802.11HEW wireless standard.

### EXAMPLE 29

The method of either of examples 22 to 23, wherein the unique identifier is between 4 and 20 bits.

### EXAMPLE 30

The method of either of examples 22 to 23, wherein the unique identifier is between 4 and 8 bits.

### EXAMPLE 31

The apparatus of either of examples 22 to 23, wherein the transmitter node is an access point in the wireless network.

### EXAMPLE 32

A method implemented by a node in a wireless network. The method may comprise receiving a physical layer convergence protocol header corresponding to a packet to be transmitted from a transmitter node in the wireless network to a receiver node in the wireless network and decoding a unique identifier from the physical layer convergence protocol header, the unique identifier corresponding to a connection between the transmitter node and the receiver node.

### EXAMPLE 33

The method of example 32, further comprising determining whether the node in the wireless system corresponds to the receiver node in the wireless system based at least in part on the unique identifier.

### EXAMPLE 34

The method of example 33, further comprising applying interference nulling to a signal corresponding to the packet based on the determination that the node in the wireless system does not correspond to the receiver node in the wireless system.

### EXAMPLE 35

The method of example 33, further comprising applying a transmission scheme to a signal corresponding to the packet based on the determination that the node in the wireless system does correspond to the receiver node in the wireless system.

### EXAMPLE 36

The method of example 35, determining the transmission scheme based at least in part on a quality of service requirement for the packet.

### EXAMPLE 37

The method of example 33, further comprising initiating a power saving operation in the node based on the determination that the node in the wireless system does not correspond to the receiver node in the wireless system.

### EXAMPLE 38

The method of example 33, further comprising receiving the packet and decoding the packet based on the determination that the node in the wireless system does correspond to the receiver node in the wireless system.

### EXAMPLE 39

The method of example 38, further comprising determining whether a portion of the packet was not correctly received and requesting a retransmission of the packet from transmitting node based on the determination that the portion of the packet was not correctly received.

### EXAMPLE 40

The method of either of examples 32 to 39, wherein the unique identifier is in a high-efficiency wireless local area network (HEW) signal field in the physical layer convergence protocol header.

### EXAMPLE 41

The method of example 40, wherein the transmitter node and the receiver node are configured to operate on the 802.11HEW wireless standard.

### EXAMPLE 42

The method of examples 32 to 39, wherein the transmitter node is an access point in the wireless network and the node is a station in the wireless network.

### EXAMPLE 43

An apparatus comprising means to perform the method of any of examples 22 to 42.

### EXAMPLE 44

At least one machine readable medium comprising a plurality of instructions that in response to being executed on a transmitter node and/or a receiver node in a wireless network cause any one the transmitter node and/or receiver node to perform the method of any of examples 22 to 42.

### EXAMPLE 45

An apparatus for a wireless network comprising a processor, a radio operably connected to the processor, one or more antennas operably connected to the radio to transmit or receive wireless signals, and a memory comprising a plurality of instructions that in response to being executed by the processor cause the processor or the radio to perform the method of any of claims 22 to 42.

1. An apparatus for a transmitter node in a wireless network comprising:
a connection identifier to generate a unique identifier corresponding to a connection between the transmitter node and a receiver node in the wireless network; and
a data packet transmitter to embed the unique identifier into a physical layer convergence protocol header corresponding to a packet to be transmitted to the receiver node.

2. The apparatus of claim 1, wherein the data packet transmitter embeds the unique identifier into a high-efficiency wireless local area network (HEW) signal field in the physical layer convergence protocol header.

3. The apparatus of claim 1, wherein the connection identifier randomly generates the unique identifier.

4. The apparatus of claim 1, wherein the connection identifier allocates the unique identification from a pool of available unique identifiers.

5. The apparatus of claim 1, wherein the unique identifier is a first unique identifier and the receiver node is a first receiver node, the connection identification to generate a second unique identifier corresponding to a connection between the transmitter node and a second receiver node in the wireless network.

6. The apparatus of claim 5, wherein the packet is to be transmitted to the second receiver node, the data packet transmitter to embed the second unique identifier into the physical layer convergence protocol header corresponding the packet.

7. The apparatus claim 2, wherein the transmitter node and the receiver node are configured to operate on the 802.11HEW wireless standard.

8. An apparatus for a node in a wireless network comprising:
a data packet receiver to receive a physical layer convergence protocol header corresponding to a packet to be transmitted from a transmitter node in the wireless network to a receiver node in the wireless network; and
a header decoder to decode a unique identifier from the physical layer convergence protocol header, the unique identifier corresponding to a connection between the transmitter node and the receiver node.

9. The apparatus of claim 8, further comprising a receiver identifier to determine whether the node in the wireless system corresponds to the receiver node in the wireless system based at least in part on the unique identifier.

10. The apparatus of claim 9, further comprising an interference nuller to apply interference nulling to a signal corresponding to the packet based on the determination that the node in the wireless system does not correspond to the receiver node in the wireless system.

11. The apparatus of claim 9, further comprising a quality of service module to apply a transmission scheme to a signal corresponding to the packet based on the determination that the node in the wireless system does correspond to the receiver node in the wireless system.

12. The apparatus of claim 11, the quality of service module to determine the transmission scheme based at least in part on a quality of service requirement for the packet.

13. The apparatus of claim 9, further comprising a power saver to initiate a power saving operation in the node based on the determination that the node in the wireless system does not correspond to the receiver node in the wireless system.

14. The apparatus of claim 9, further comprising a payload decoder to receive the packet and decode the packet based on the determination that the node in the wireless system does correspond to the receiver node in the wireless system.

15. The apparatus of claim 14, further comprising an error corrector to determine whether a portion of the packet was not correctly received and request a retransmission of the packet from transmitting node based on the determination that the portion of the packet was not correctly received.

16. The apparatus of claim 8, wherein the unique identifier is in a high-efficiency wireless local area network (HEW) signal field in the physical layer convergence protocol header.

17. The apparatus of claim 16, wherein the transmitter node and the receiver node are configured to operate on the 802.11HEW wireless standard.

18. An apparatus for a wireless network comprising:
a processor;
a radio operably connected to the processor;
one or more antennas operably connected to the radio to receive wireless signals from a transmitter node; and
a memory comprising a plurality of instructions that in response to being executed by the processor cause the apparatus to:
receive a physical layer convergence protocol header corresponding to a packet to be transmitted from the transmitter node in the wireless network to a receiver node in the wireless network; and
decode a unique identifier from the physical layer convergence protocol header, the unique identifier corresponding to a connection between the transmitter node and the receiver node.

19. The apparatus of claim 18, wherein the plurality of instructions in response to being executed by the processor further cause the apparatus to determine whether the node in the wireless system corresponds to the receiver node in the wireless system based at least in part on the unique identifier.

20. The apparatus of claim 19, wherein the plurality of instructions in response to being executed on the processor further cause the apparatus to reduce power to the radio based on the determination that the node in the wireless system does not correspond to the receiver node in the wireless system.

21. The apparatus of claim 19, wherein the unique identifier is in a high-efficiency wireless local area network (HEW) signal field in the physical layer convergence protocol header.

22. At least one machine readable medium comprising a plurality of instructions that in response to being executed on a receiver node in a wireless network cause the receiver node to:
receive a physical layer convergence protocol header corresponding to a packet to be transmitted from a transmitter node in the wireless network to a receiver node in the wireless network; and
decode a unique identifier from the physical layer convergence protocol header, the unique identifier corresponding to a connection between the transmitter node and the receiver node.

23. The at least one machine readable medium of claim 22, further comprising instructions that in response to being executed on the receiver node cause the receiver node to determine whether the node in the wireless system corresponds to the receiver node in the wireless system based at least in part on the unique identifier.

24. The at least one machine readable medium of claim 23, further comprising instructions that in response to being executed on the receiver node cause the receiver node to initiate a power saving operation in the node based on the determination that the node in the wireless system does not correspond to the receiver node in the wireless system.

25. The at least one machine readable medium of claim 23, wherein the unique identifier is in a high-efficiency wireless local area network (HEW) signal field in the physical layer convergence protocol header.
